(19) United States
(12) Patent Application Publication
(10) Pub. No.: US 2018/0017224 A1
(43) Pub. Date: Jan. 18, 2018

(54) VEHICLE LAMP ASSEMBLY WITH REAR-LIT OLED

(71) Applicant: GM GLOBAL TECHNOLOGY OPERATIONS LLC, Detroit, MI (US)

(72) Inventor: Brenton J. Sirowatka, Royal Oak, MI (US)

(73) Assignee: GM GLOBAL TECHNOLOGY OPERATIONS LLC, Detroit, MI (US)

(21) Appl. No.: 15/207,826

(22) Filed: Jul. 12, 2016

(51) Int. Cl. F21S 8/10; F21V 23/00

(52) U.S. Cl. CPC F21S 48/1163; F21V 23/003; F21S 48/31; F21S 48/23; F21S 48/2212; F21S 48/217; F21S 48/215; F21S 48/1159; F21S 48/13; F21S 48/1233; F21Y 2115/15; F21Y 2115/10

(57) ABSTRACT

Lamp assemblies, motorized vehicles with lamp assemblies, and methods of constructing and methods of using lamp assemblies are disclosed. A lamp assembly is disclosed that includes a lamp housing that is configured to attach to a motor vehicle's front-end or rear-end vehicle structure. A transparent lens is attached to the lamp housing. The lamp assembly also includes an organic light emitting diode (OLED) panel with a transmissive substrate layer that is attached to the lamp housing. An electroluminescent layer, which generates light in response to an electric signal, is coupled to the transmissive substrate layer. The electroluminescent layer is configured to selectively emit light through the lens. A light source is also attached to the lamp housing and is configured to emit light through the OLED panel and out through the lens.

### TECHNICAL FIELD

The present disclosure relates generally to lamp assemblies for motor vehicles. More specifically, aspects of this disclosure relate to vehicle headlights and taillights with solid state lighting (SSL) elements, such as light-emitting diodes (LEDs), organic light-emitting diodes (OLEDs), or polymer light-emitting diodes (PLEDs).

### BACKGROUND

Current production motor vehicles, such as the modern-day automobile, are originally equipped with a lighting system to provide interior and exterior illumination for the vehicle operator. Such lighting systems include an assortment of lamp assemblies that are mounted or otherwise integrated to the front, sides and rear of the vehicle. The purpose of these lamp assemblies is to provide exterior illumination for the driver, for example, to operate the vehicle in low-light conditions, such as nighttime driving, and to increase the conspicuity of the vehicle. Such lighting systems can also display information about the vehicle's presence, position, size, direction of travel, as well as provide signaling functions to indicate the operator's intended maneuvering of the vehicle.

Most conventional automobiles are equipped with taillight assemblies that include directional signals to convey the driver's intent to turn the vehicle, and rear brake lights to indicate that the vehicle is slowing or stopping. Generally fitted in multiples of two, symmetrically at the left and right edges of the vehicle rear, the brake lights are red, steady-burning lamps that are illuminated when the driver applies pressure to the brake pedal. Many automobiles are also equipped with a central brake lamp that is mounted higher than the vehicle's traditional left and right brake lamps. The central brake lamp is known as a center high-mounted stop lamp, or “CHMSL” (pronounced chim-zul). The CHMSL is intended to provide a notice of deceleration to following drivers whose view of the vehicle's regular stop lamps is blocked by interceding vehicles.

In addition to the above-mentioned brake light assemblies, current production automobiles are also equipped with front-mounted headlamps. With a similar arrangement to the rear-mounted taillights, an individual headlamp assembly is typically mounted at both the front-left and front-right corners of the vehicle. The headlamp is generally designed to provide forward illumination in two different settings: a “low-beam setting, which provides adequate forward and lateral illumination for normal driving conditions with minimized glare, and a “high-beam” setting, which provides an intense, center-weighted distribution of light that is primarily suitable for driving scenarios where on-coming drivers are not present. Most headlamps are also provided with directional signals (more commonly known as “turn signals” or colloquially as “blinkers”).

Headlamp assemblies, in addition to forward illumination functions, may include multiple lamps to provide various features. Daytime running lamps, also known as daylight running lamps (or “DRL” for short), are provided to increase the conspicuity of the vehicle during daylight conditions. DRLs automatically switch on when the vehicle is shifted into drive. These may be functionally-dedicated lamps incorporated into the vehicle design, or may be provided, for example, by the low- or high-beam headlamps. Similarly, nighttime standing-vehicle conspicuity to the front is provided by white or amber light emitted from front position lamps, more commonly known as “parking lamps”.

Conventional lamp assemblies include numerous internal parts, such as various brackets, multiple reflectors, numerous filament-type light bulbs, internal adjuster mechanisms, and, in some cases, a projector lamp. Traditionally, the entire lamp assembly is pre-assembled into a protective lamp housing prior to integration with the vehicle. A protective outer lens is also necessary to shield the internal lamp componentry from external debris, weather, and the like. The complexity of such prior art lamp assemblies adds to the cost of manufacturing the assembly, which in turn adds to the cost of the automobile. In addition, the large number of parts required to operate some conventional lamp assemblies consumes valuable packaging space in the front fascia of the automobile.

### SUMMARY

Disclosed herein are vehicle lamp assemblies, methods for making and using vehicle lamp assemblies, and motor vehicles with one or more lamp assemblies. By way of non-limiting example, an improved lamp assembly, which may be in the nature of a headlight or taillight, implements one or more light-emitting diodes (LEDs) or other high-intensity high-luminosity light source such that light generated therefrom passes through an organic light-emitting diode (OLED) panel disposed in the lamp housing. By modulating the light passed through the OLED panel by the high-intensity light source, light transmitted from the OLED panel can be supplemented to increase overall lumen output of the lamp assembly. Operating a high-intensity light source in conjunction with the OLED panel allows for high luminous output functions to be met, and new lamp design opportunities to be achieved. As another exemplary advantage, the disclosed lamp assembly allows for the use of less-expensive OLED panels (e.g., SDTV 30-50 lumens per watt) versus high luminous OLED panels (e.g., 110-130 lumens per watt) while maintaining desired light output. OLEDs provide design advantages over conventional filament bulbs and other single-point light sources by being able to emit light from an entire surface rather than just a single location.

Aspects of the present disclosure are directed to vehicle lamp assemblies for motor vehicles. For example, a vehicle lamp assembly is disclosed that includes a lamp housing, a transparent or generally transparent lens, an OLED panel, and a light source, such as a high-intensity LED. The lamp housing is configured to attach to a motor vehicle's front-end or rear-end vehicle structure (e.g., within a lamp well above the front or rear bumper). The lens is attached to the lamp housing. The OLED panel has a transmissive substrate layer that is attached to the lamp housing, and an electroluminescent layer coupled to the transmissive substrate layer. This electroluminescent layer is configured to emit light through the lens. The light source, which is also attached to the lamp housing, is configured to emit light through the OLED panel, whether active or inactive, and out through the lens.

Other aspects of the present disclosure are directed to motor vehicles with lamp assemblies. The motor vehicle may include any relevant platform, such as passenger vehicles (internal combustion engine (ICE), hybrid, electric, etc.), industrial vehicles, buses, all-terrain vehicles (ATV), motorcycles, farm equipment, boats, airplanes, etc. In one example, a motor vehicle includes a vehicle body with front-end and rear-end vehicle structure. A lamp assembly with a lamp housing is mounted to the front-end or rear-end of the vehicle structure. A transparent/generally transparent lens is attached to the lamp housing to define a cavity therebetween. The lamp assembly also includes an OLED panel having a transmissive substrate layer that is mounted inside the cavity of the lamp housing. An electroluminescent layer is coupled to the transmissive substrate layer and configured to emit light through the lens. In addition, a light source is mounted inside the cavity of the lamp housing. This light source is configured to emit light through the transmissive substrate layer of the OLED panel and out of the lamp assembly through the lens.

According to other aspects of the present disclosure, methods of making and methods of using lamp assemblies are presented. For instance, a method of constructing a lamp assembly for a motor vehicle is disclosed. The method includes: providing a lamp housing configured to attach to the motor vehicle's vehicle structure; attaching a transparent or generally transparent lens to the lamp housing; attaching an organic light emitting diode (OLED) panel to the lamp housing, the OLED panel having a transmissive substrate layer and an electroluminescent layer coupled to the transmissive substrate layer, the electroluminescent layer being configured to emit light through the lens; and, attaching a light source to the lamp housing, the light source being configured to emit light through the OLED panel and out through the lens.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a front perspective-view illustration of a portion of a representative motorized vehicle with a vehicle lamp assembly in accordance with aspects of the present disclosure.

FIG. 2 is a schematic side-view illustration of the representative vehicle lamp assembly of FIG. 1, shown with the OLED panel and LED light source operating in a first mode.

FIG. 3 is another schematic side-view illustration of the representative vehicle lamp assembly of FIG. 1, shown with the OLED panel and LED light source operating in a second mode.

The present disclosure is susceptible to various modifications and alternative forms, and some representative embodiments have been shown by way of example in the drawings and will be described in detail herein. It should be understood, however, that the inventive aspects of this disclosure are not limited to the particular forms disclosed. Rather, the disclosure is to cover all modifications, equivalents, combinations, subcombinations, and alternatives falling within the spirit and scope of the disclosure as defined by the appended claims.

### DETAILED DESCRIPTION OF THE ILLUSTRATED EMBODIMENTS

This disclosure is susceptible of embodiment in many different forms. There are shown in the drawings and will herein be described in detail representative embodiments of the disclosure with the understanding that the present disclosure is to be considered as an exemplification of the principles of the disclosure and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

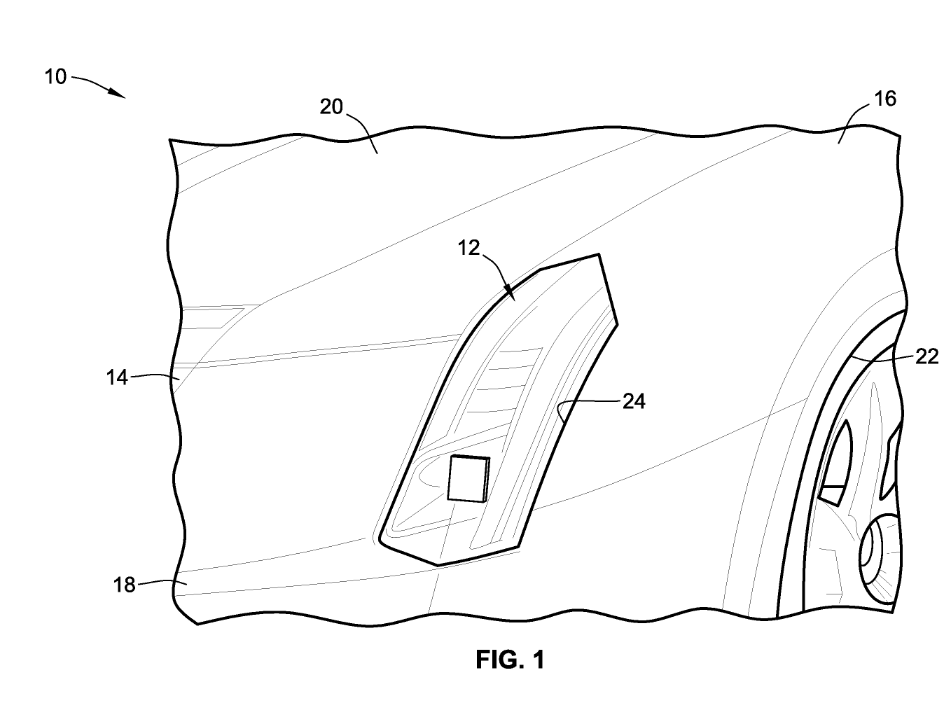

Referring now to the drawings, wherein like reference numbers refer to like features throughout the several views, there is shown in FIG. 1 a front-view illustration of a representative automobile, designated generally at 10, in accordance with aspects of the present disclosure. Mounted at a forward portion of the automobile 10, in between the automobile's front grille 14 and a front fender panel 16, is a vehicle lamp assembly 12. The automobile 10—also referred to herein as “motor vehicle” or “vehicle” for short—is merely an exemplary application with which the inventive aspects of this disclosure can be practiced. In the same vein, the implementation of the present concepts into a headlight assembly should also be appreciated as an exemplary application of the inventive concepts disclosed herein. As such, it should be understood that the inventive features of the present disclosure can be integrated into other vehicle lamp assemblies and utilized for any type of motor vehicle. Lastly, the drawings presented herein, are not necessarily to scale and are provided purely for instructional purposes. Thus, the specific and relative dimensions shown in the drawings are not to be construed as limiting.

FIG. 1 is illustrative of the automobile's 10 vehicle body, which can be divided for purposes of this description into front vehicle structure that is adjacent to and forward of rear vehicle structure (not visible in the view provided). The front vehicle structure is represented herein by the front grille 14, the fender panel 16, a front fascia panel 18 and a movable hood assembly 20. Front fascia panel 18 extends transversely across the forward most portion of the vehicle 10 to cover and conceal, among other things, an energy absorbing bumper substructure (not visible). The front fascia panel 18 is forward of a movable hood assembly 20 that spans over and covers the automobile's 10 forward engine compartment (not visible). The front fascia 18 cooperates with right-hand front fender panel 16 to define the peripheral contour of a front-right wheel well, which is designated generally at 22. The front fascia 18 also cooperates with the front fender panel 16 and hood assembly 20 to define a front-right lamp well, illustrated at 24 in FIG. 1. Packaged within the lamp well 24 is a corresponding vehicle lamp assembly 12 (only the right-hand assembly is evident in FIG. 1, but a mirror-image, left-hand counterpart is also present in this particular embodiment).

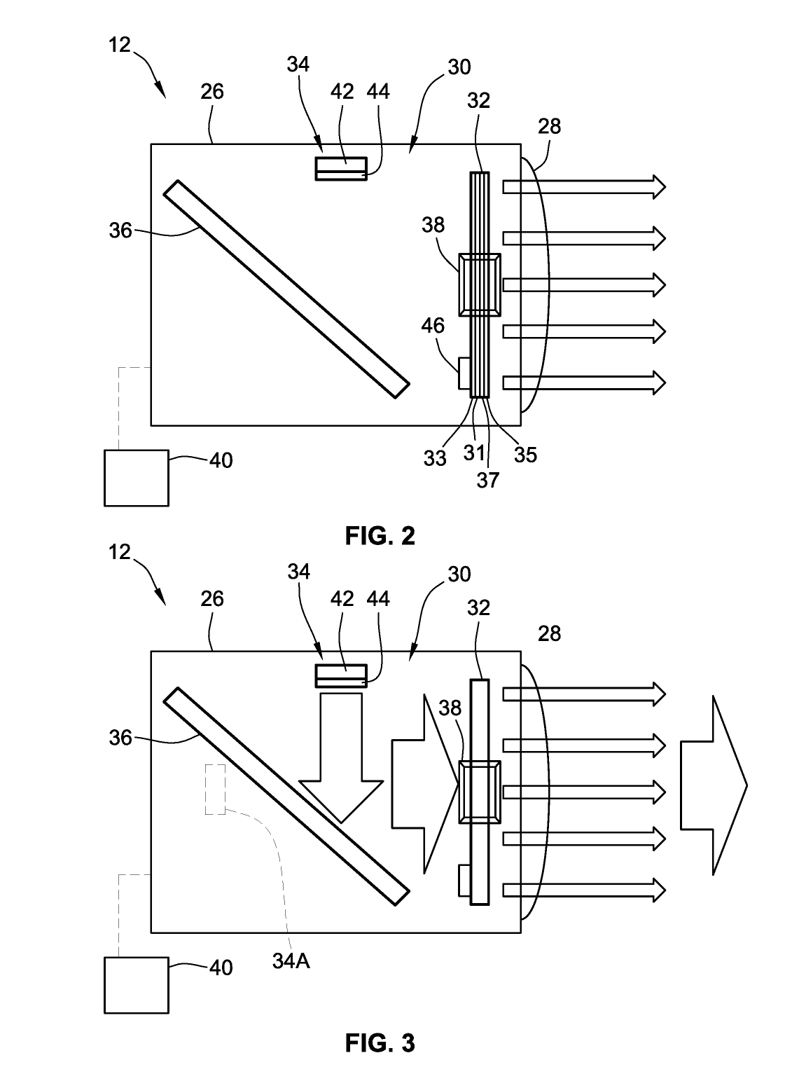

Turning to FIGS. 2 and 3, the vehicle lamp assembly 12 is schematically illustrated in accordance with one embodiment of the present disclosure. The lamp assembly 12 includes a lamp housing 26 with a transparent or generally transparent protective outer lens 28 mounted to a forward end of the lamp housing 26. The lamp housing 26, which can be made of a hydroformed plastic material, is designed to fit within the lamp well 24. The lamp housing 26 includes a plurality of attachments (e.g., snap fasteners, mounting tabs, threaded bolt cavities, etc.) by which the lamp assembly 24 is mounted to the vehicle structure. The outer lens 28, which serves as a protective barrier from the outside environment while still allowing light to pass out of the assembly, may be comprised of transparent or semi-transparent materials such as polycarbonate or acrylic.

A forward-illuminating, high-beam/low-beam lighting arrangement, designated generally as 30, is encased within the lamp housing 26. With reference to FIG. 2, the lamp assembly 24 is provided with an organic light-emitting diode (OLED) panel 32 and a light source 34, both of which are operable to generate and emit light. Recognizably, the light source 34 may take on various configurations, such as a halogen bulb, a gas-discharge light source, or an incandescent lamp. In the embodiment of FIGS. 2 and 3, however, the light source is a light emitting diode (LED) module and, in at least some preferred configurations, a high-intensity discharge (HID) lamp, high-luminosity laser, or a high-intensity high-luminosity LED module 34. In at least some configurations, a high-intensity high-luminosity light source operates at about 15-25 lumens per watt per LED and/or a total output of about 2500 lumens to about 4800 lumens. By contrast, the OLED panel 32 may be a rigid glass OLED panel, such as a glass-printed transparent thin film transistor (TFT) screen, or may be a flexible plastic OLED panel, such as flexible polymer Active-Matrix Organic Light-Emitting Diode (AMOLED) screen. As shown, the OLED panel 32 is a white-light OLED panel or a monochromatic (e.g., blue light) OLED panel. For at least some embodiments, the OLED panel comprises a standard definition (SD) display panel with an output of approximately 30-50 lumens per watt and/or a total output of about 450 lumens to about 800 lumens. Alternatively, the OLED panel may be multichromatic.

According to the illustrated example of FIG. 2, a light-emitting layer of an organic electroluminescent (EL) material (also referred to herein as “electroluminescent layer”) 31, such as a light-emitting polymer, with adjacent semiconductor layers (not shown) are located between a cathode and anode (not shown). Organic EL materials emit electromagnetic (“EM”) radiation having narrow ranges of wavelengths in the visible spectrum in response to the application of an electric signal. The organic electroluminescent layer 31 is overlaying a surface of a rigid or flexible transmissive substrate 33. The transmissive substrate 33 may comprise, for example, any of the following: an organic polymeric material; polyethylene terephthalate (“PET”); polyacrylates; polycarbonates; silicone; epoxy resins; silicone-functionalized epoxy resins; polyesters; polyimides; polyethersulfones; polyetherimide; polyethylene naphthalate (“PEN”); or other transparent or translucent materials. To achieve white light, in one particular example, the OLED panel 32 incorporates closely arranged OLEDs emitting blue, green, and red light, or complementary colors of light (e.g., blue and yellow); these colors are mixed to produce white light. The OLED panel 32 may have a light transmittance of about 45% to about 80%.

An optional diffuser layer 35, which may be in the nature of a Diffractive Optical Element (DOE) that shapes emitted monochromatic light in a specific spatial configuration and intensity profile, is positioned forward of the electroluminescent layer 31 and transmissive substrate 33 of the OLED panel 32. As shown, a color or polarizing optical filter layer 37 is disposed between the electroluminescent layer 31 and the diffuser layer 35. The light emitting electroluminescent layer 31 may itself include multiple sublayers, each comprising a different organic EL material. In this regard, the OLED panel 32 may comprise additional layers and/or other conventional features without departing from the intended scope of the present disclosure. A rigid bezel 38 mounts the OLED panel 32 to the lamp housing 26.

The vehicle lamp assembly 12 is designed to function in at least two different operating modes: a first “low-intensity” mode, which can be used, e.g., for daytime running lamp (DRL) or taillight functions, and a second “high-intensity” mode, which can be used, e.g., for low-beam, high-beam, or stop functions. When in the low-intensity mode, which is shown in FIG. 2, the lighting arrangement 30 emits a distribution of light that provides adequate light to increase the overall conspicuity of the vehicle. When in the high-intensity mode, which is shown in FIG. 3, the lighting arrangement 30 can provide a “low-beam” functionality that emits a distribution of light that provides adequate forward and lateral illumination for normal vehicle operation (e.g., 450-850 lumens), while limiting light disbursement to control glare to other drivers. By way of comparison, the high-intensity operating mode can also provide a “high-beam” functionality that emits a center-weighted distribution of light that provides increased forward and lateral illumination (e.g., 850-1500 lumens), for example, for low-light and low-visibility vehicle operation. For the low-intensity mode, the OLED panel 32 is activated such that the electroluminescent layer 31 emits light in a forward direction (to the right in FIG. 2) through the lens 28 to provide the requisite (DRL or tail) functionality. The light source 34 is not activated in FIG. 2 and, thus, does not supplement the light emitted by the OLED panel 32. Comparatively, in FIG. 3, the light source 34 emits light through the rear of the OLED panel 32 and out through the lens 28, thereby supplementing the light emitted by the OLED panel 32 through the lens 28, to provide the requisite low-beam or high-beam or stop-lamp functionality.

The light source 34 of FIGS. 2 and 3 is packaged such that the light emitting face thereof is angularly offset (e.g., at an approximately 90 degree angle) from the OLED panel 32 to transmit light at a non-normal angle of incidence with respect to the rear face of the OLED panel 32. A reflector 36, which is mounted inside of the lamp housing 36, operates to reflect or otherwise redirect light emitted by the light source 34 through the OLED panel 32. Alternatively, the reflector 36 can be omitted from the vehicle light assembly 12, and the OLED panel 32 positioned between the light source (shown schematically at 34A) and the lamp lens 28 such that the light source 34 transmits light at a normal or near-normal angle of incidence with respect to the rear face of the OLED panel 32. In some configurations, the lamp assembly 12 may comprise a lens array or other optical means to converge light, such as a gradient-index (GRIN) lens array or a SELFOC lens array, or may comprise a standard transparent quartz cover glass.

To control operation of the lighting arrangement 30, a controller 40 is communicatively coupled to the OLED panel 32 and the light source 34. For configurations employing a high-intensity LED module, the light source 34 comprises an LED printed circuit board (PCB) 42 with an array of discrete LED's 44 mounted to a printed circuit board 42 along with other components based on a desired drive scheme and design requirements. To this end, OLED panel 32 comprises an OLED PCB 46 with driver and control circuits for the OLED lamp. The controller 40, in conjunction with the LED PCB 42 and the OLED PCB 44, operate the OLED panel 32 and the light source 34 in the aforementioned low-intensity mode, during which the OLED panel 32 is active and the light source 34 is inactive, and high-intensity mode, during which both the OLED panel 32 and the light source 34 are simultaneously active.

While aspects of the present disclosure have been described in detail with reference to the illustrated embodiments, those skilled in the art will recognize that many changes may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and subcombinations of the preceding elements and aspects.

What is claimed:

1. A vehicle lamp assembly for a motor vehicle having a vehicle structure, the lamp assembly comprising:
a lamp housing configured to attach to the vehicle structure;
a transparent or generally transparent lens attached to the lamp housing;
an organic light emitting diode (OLED) panel having a transmissive substrate layer attached to the lamp housing and an electroluminescent layer coupled to the transmissive substrate layer, the electroluminescent layer being configured to emit light through the lens; and
a light source attached to the lamp housing and configured to emit light through the OLED panel and out through the lens.

2. The vehicle lamp assembly of claim 1, further comprising a reflector attached to the lamp housing and configured to reflect the light emitted by the light source through the OLED panel.

3. The vehicle lamp assembly of claim 1, further comprising a controller communicatively coupled to the OLED panel and the light source.

4. The vehicle lamp assembly of claim 3, wherein the controller is configured to operate the OLED panel and the light source in a first operating mode, during which the OLED panel is active and the light source is inactive, and a second operating mode, during which both the OLED panel and the light source are simultaneously active.

5. The vehicle lamp assembly of claim 1, wherein the light source includes a light emitting diode (LED) module.

6. The vehicle lamp assembly of claim 5, wherein the light source consists essentially of a high-intensity high-luminosity LED module.

7. The vehicle lamp assembly of claim 1, wherein the OLED panel is positioned between the light source and the lens.

8. The vehicle lamp assembly of claim 1, further comprising a bezel mounting the OLED panel to the lamp housing.

9. The vehicle lamp assembly of claim 1, wherein the OLED panel further comprises a diffuser layer and a filter layer, the filter layer being disposed between the electroluminescent layer and the diffuser layer.

10. The vehicle lamp assembly of claim 1, wherein the OLED panel includes a white-light OLED panel or a monochromatic OLED panel.

11. A motor vehicle, comprising:
a vehicle body having opposing front-end and rear-end vehicle structure; and
a lamp assembly including:
a lamp housing mounted to one of the front-end and rear-end vehicle structure;
a transparent or generally transparent lens attached to the lamp housing to define a cavity therebetween;
an organic light emitting diode (OLED) panel having a transmissive substrate layer mounted inside the cavity of the lamp housing, and an electroluminescent layer coupled to the transmissive substrate layer, the electroluminescent layer being configured to emit light through the lens; and
a light source mounted inside the cavity of the lamp housing, the light source being configured to emit light through the transmissive substrate layer of the OLED panel and out of the lamp assembly through the lens.

12. A method of constructing a lamp assembly for a motor vehicle having a vehicle structure, the method comprising:
providing a lamp housing configured to attach to the vehicle structure;
attaching a transparent or generally transparent lens to the lamp housing;
attaching an organic light emitting diode (OLED) panel to the lamp housing, the OLED panel having a transmissive substrate layer and an electroluminescent layer coupled to the transmissive substrate layer, the electroluminescent layer being configured to emit light through the lens; and
attaching a light source to the lamp housing, the light source being configured to emit light through the OLED panel and out through the lens.

13. The method of claim 12, further comprising attaching a reflector to the lamp housing, the reflector being configured to reflect the light emitted by the light source through the OLED panel and out through the lens.

14. The method of claim 12, further comprising communicatively coupling a controller to the OLED panel and the light source.

15. The method of claim 14, wherein the controller is configured to operate the OLED panel and the light source in a first low-intensity operating mode, during which the OLED is active and the light source is inactive, and a second high-intensity operating mode, during which both the OLED and the light source are active.

16. The method of claim 12, wherein the light source includes a light emitting diode (LED) module.

17. The method of claim 12, wherein the OLED panel is positioned between the light source and the lens.

18. The method of claim 12, wherein the attaching the OLED panel includes mounting the OLED panel to a bezel, and mounting the bezel to the lamp housing.

19. The method of claim 12, wherein the OLED panel further comprises a diffuser layer and a filter layer disposed between the electroluminescent layer and the diffuser layer.

20. The method of claim 12, wherein the OLED panel is a white-light OLED panel or a monochromatic OLED panel.
